(19) United States
(12) Patent Application Publication
(10) Pub. No.: US 2023/0166934 A1
(43) Pub. Date: Jun. 1, 2023

(54) DETERMINING LATERAL WEB MISALIGNMENT

(71) Applicant: Hewlett-Packard Development Company, L.P., Spring, TX (US)

(72) Inventors: Eli VELNER, Nes Ziona (IL); Avihay ARGAMAN, Alpharetta, GA (US); Bar-Navi MIKI, Nes Ziona (IL); Zelidor FINEBERG, Nes Ziona (IL); Eyal GRAUER, Nes Ziona (IL); Omer VASERMAN, Nes Ziona (IL)

(73) Assignee: Hewlett-Packard Development Company, L.P., Spring, TX (US)

(21) Appl. No.: 17/997,263

(22) PCT Filed: Apr. 28, 2020
(86) PCT No.: PCT/US2020/030294

§ 371 Date: Oct. 27, 2022

(51) Int. Cl. B65H 23/02; B41J 11/42; B65H 23/032; B65H 26/00; G01B 11/14

(52) U.S. Cl. CPC B65H 23/0216; B41J 11/42; B65H 23/032; B65H 26/00; G01B 11/14; B65H 2511/512

(57) ABSTRACT

In an example of the disclosure, a first optical sensor positioned adjacent to a web path and having a first sensor beam is utilized to identify a first signal value as the first optical sensor detects an eye-mark as the web is moved along the web path. A second optical sensor positioned adjacent to the web path, downstream of the first optical sensor, and having a second sensor beam, is utilized to identify a second signal value as the second optical sensor detects the eye-mark. A lateral misalignment of the web is determined based upon the first signal value, the second signal value, and a lateral offset of the first sensor beam from the second sensor beam.

### BACKGROUND

A printer may apply marking agents to a paper or another media to produce an image upon the media. One example of printer is a web-fed printer device, wherein during production printing marking agent application components apply the marking agents to a web media fed through the printer device via a series of rollers. In certain examples, the marking agent application components may apply the marking agent via inkjet (e.g., thermal inkjet or piezo inkjet), liquid ink, liquid toner, or dry toner printing technologies. Following the application of the marking agents, the web media may be collected on a take-up reel or cut into sheets by a finishing device that is in-line with the printer.

### DRAWINGS

FIG. 1 is a block diagram depicting an example of a system for determining lateral misalignment of a web.

FIG. 2 is a block diagram depicting another example of a system for determining lateral misalignment of a web

FIG. 3 is a block diagram depicting a memory resource and a processing resource to implement an example of a method for determining lateral misalignment of a web.

FIGS. 4, 5A, 5B, and 5C are simple schematic diagrams that illustrate an example of a system for determining lateral misalignment of a web.

FIG. 6 includes a simple schematic diagram and a corresponding chart that illustrate an example of a system for determining lateral misalignment of a web.

FIG. 7 is a simple schematic diagram that illustrates an example of system for determining lateral misalignment of a web, where the first and second optical sensors are positioned within a printer and are also utilized in front to back registration processes.

FIG. 8 is a flow diagram depicting an example implementation of a method for determining lateral misalignment of a web.

FIG. 9 is a flow diagram depicting an example implementation of a method for determining lateral misalignment of a web, including determining a degree and direction of misalignment and initiating a corrective measure.

### DETAILED DESCRIPTION

Web-fed printers can be used to print commercial or industrial print jobs one after the other upon a media. Commonly finishing processing (e.g., a cutting, folding, stapling, and/or corrugating) of the printed jobs occurs at a finishing device separate from, or in-line with, the web-fed printer device. In order to enable accurate printing and to enable the finishing device to operate precisely, the web media must be precisely aligned laterally such that the printer will print images upon the media with correct registration. Web media may move laterally from the intended position due a variety of factors including a very long web route, inaccurate press preliminary adjustment, an aggressive web motion profile, the width and weight of the media being conveyed through the printer, web migration as the result of stretching of the web as the web absorbs water from the printing process, and shrinking of the web as the web is dried in a dryer.

If the web is not in correct alignment, the images printed thereon may be printed out of position (e.g., an image is printed too far to one side relative the web-advance direction, and/or out alignment with another image printed on an opposite side of the web media). In cases of duplex printing, the images printed upon the media also must be properly registered with respect to the front side and the back side of the media. In some situations, in addition to print quality issues, an extreme web lateral misalignment can cause mechanical failures at the printer. Current systems may utilize an “open loop” control system to inspect the web itself and correct lateral motion and position of the web based upon such inspection. However, in certain circumstances such systems may not afford the accuracy and/or the speed of recognition of a misalignment issue needed to avoid print quality issues and wasted resources (e.g. cost of printing fluids, media, press time, operator time, repair of damaged equipment, and opportunity cost). With these conditions operations and post-printing operations can be significantly affected.

To address these issues, various examples described in more detail below provide a system and a method for determining lateral web misalignment. In an example of the disclosure, a first optical sensor is positioned adjacent to a web path. The first optical sensor is to emit a first sensor beam and produce a first signal value upon its detection of an eye-mark as the web is moved along the web path. A second optical sensor is to be positioned adjacent to the web path and downstream of the first optical sensor. The second optical sensor is to emit a second sensor beam that is to be at a lateral position relative to the web path that is offset from the lateral position of the first sensor beam. The second optical sensor to produce a second signal value upon its detection of the eye-mark as the web is moved along the web path. A lateral misalignment of the web is determined based upon the values of the first and second signals and a lateral offset of the second sensor beam from the first sensor beam.

In examples, the described offset between the first and second sensor beams is within an acceptable engineering tolerance such that the offset does not affect other required functions of the sensors. In this manner, utilizing a slight offset positioning of existing sensors can enable the lateral misalignment method and system disclosed herein without inhibiting other performance of the sensors or requiring additional components.

In examples, a degree of web misalignment may be determined by comparing the first signal value and/or the second signal value to an expected signal value associated with the web being in correct alignment. In a particular example, the expected signal value is a value associated with another eye-mark that was fully overlapped with the first and second optical sensors as that other eye-mark was moved with the web past the first and second optical sensors. In examples, signal values from the first and second optical sensors are compared to the expected signal value, such that the degree to which the value of the first or the second signal is less than the expected signal value is proportional with the degree of web misalignment.

In examples, a direction of lateral web misalignment is to be determined in consideration of the lateral offset between the first and second sensor beams when at least one of the first and second signal values is less than an expected signal value associated with the web being in correct alignment. In one example, the first signal value produced by the first optical sensor is less than the second signal value produced by the second optical sensor, it is to be determined that the direction of lateral web misalignment points towards a lateral edge of the web that is closer to a lateral center line of the second sensor beam than to a lateral center line of the first sensor beam. Likewise, if the second signal value is less than the first signal value, it is to be determined that the direction of lateral web misalignment points towards a lateral edge of the web that is closer to a lateral center line of the first sensor beam than to a lateral center line of the second sensor beam.

In certain examples, a corrective measure is to be initiated if the determined lateral web misalignment exceeds a preestablished threshold. In one example, the corrective measure may be the issuance of an alert, e.g., a user alert, of the lateral web misalignment or another lateral. In this example, the user would then initiate corrective measures based upon the misalignment information (e.g. degree and direction of misalignment). In other examples, the corrective measure may include initiating an automated system or process for returning the web to its prescribed alignment, or other lateral web corrective measures.

In examples, the first and second optical sensors are sensors positioned within or adjacent to a printer, with the web being a web to be fed or transported through the printer.

In particular examples, the first and second optical sensors, in addition to being utilized in determining lateral web misalignment as described in this disclosure, are utilized by the printer along with other sensors to assess front to back registration of the web. Thus, in examples, the disclosed lateral misalignment method and system may be implemented without requiring additional hardware or physical components over what are used in the front to back registration system and process.

In this manner, the disclosed method and system enable a closed loop system and method to correct lateral misalignment of a web in both simplex and duplex printing use cases. In many use cases for graphics and other commercial or industrial printing this system and method will not require additional hardware (e.g., sensors) or printing of additional marks, as the disclosed system and method can leverage the use of sensors and eye-marks already being used for other commercial or industrial printing operations. Users and providers of web media printing systems will appreciate the increased accuracy in determining lateral web misalignment, the resulting increase in print quality, the cost savings of utilizing already-installed sensors, the reductions in production printing downtime, and the reductions in media and ink supplies waste afforded by the disclosure. Installations and utilization of printers that include the disclosed method and system should thereby be enhanced.

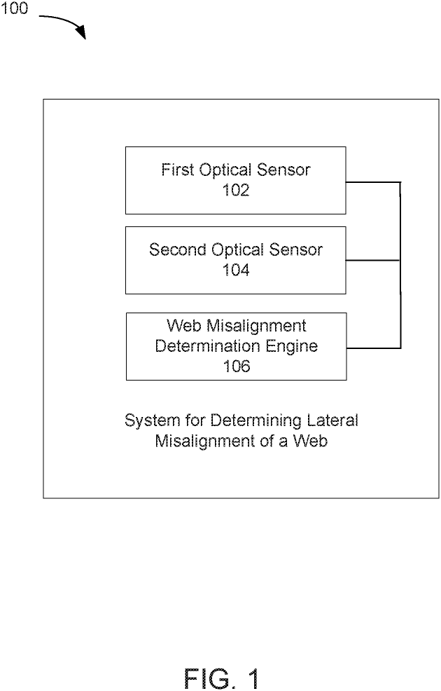

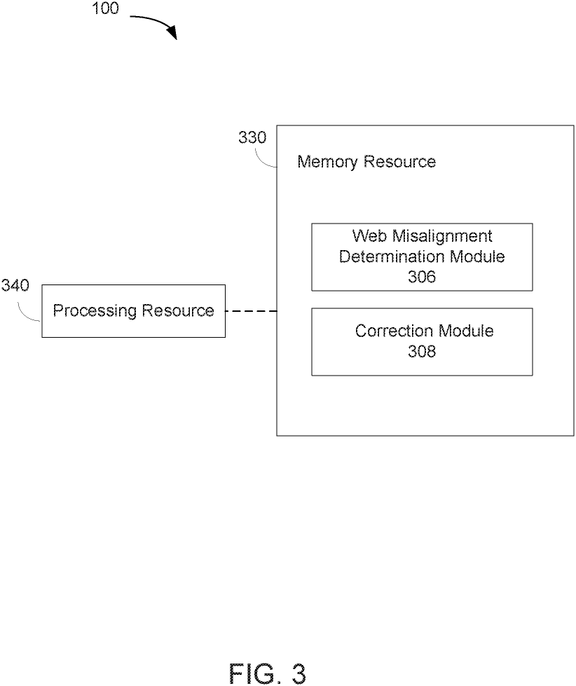

FIGS. 1-9 depict examples of physical and logical components for implementing various examples. In FIGS. 1-9 various components are identified as engines 106 and 208. In describing engines 106 and 108 focus is on each engine’s designated function. However, the term engine, as used herein, refers generally to hardware and/or programming to perform a designated function. As is illustrated with respect to FIG. 3, the hardware of each engine, for example, may include one or both of a processor and a memory, while the programming may be code stored on that memory and executable by the processor to perform the designated function.

FIG. 1 is a block diagram depicting an example of a system 100 for determining lateral misalignment of a web. In this example, system 100 includes a first optical sensor 102, and a second optical sensor 104, and a web misalignment determination engine 106 (also referred to herein as a WM determination engine). The first optical sensor 102 is positioned adjacent to a web path. As used herein an “optical sensor” refers generally to any electronic device that is to detect light, or a change in light, and convey information or data regarding the light or change of light via an electronic signal. A “web path” refers generally to a course, route, or way that a web is to travel. In examples, the web path may be established in whole or part by rollers, tracks, guides, motors, and/or other components that are to direct the web along the web path.

As used herein, a “web” refers generally to a media, paper, fabric, or other supply that is to be fed, e.g. through or adjacent to another device, as a continuous length. In examples, the web may start at a roll or reel and end at a take-up reel. In other examples, the web may in the form of a continuous belt supported by roller system. In examples, the web may be a web media that is to be fed through or adjacent to a printer. As used herein, “media”, “substrate”, “print media”, and “print substrate” are used interchangeably and refer generally to an article or object on which a printed image can be formed. In examples, a web media may be fed from a supply reel at one end of a printer, through a print zone. In examples, after application of a marking agent at the print zone, the web media may be wound upon a take-up reel at an opposite end of the printer. In examples, certain pre-printing events (e.g., application of primer) and/or post-print processing events (e.g., drying, application of overcoats, etc.) may occur at the printer, in addition to application of marking agent, to affect the web media before its collection at the take-up reel. In other examples, the web may be a supply other than a web media supply, e.g., a web of cleaning material, or a web that serves as an intermediate transfer member or blanket in a printing operation.

Continuing with the example of FIG. 1, the first optical sensor 102 is to emit a first sensor beam, and is to produce a first signal value upon the first optical sensor’s detection of an eye-mark as the web is moved along the web path. As used herein, a “sensor beam” refers generally to a stream of light, visible or infrared, emitted from a light-emitting element of an optical sensor. A “signal value” refers generally to a quantity of, or variation of, an electrical or electromechanical attribute that conveys information about a phenomenon. In examples, the signal value may be a quantity of, or a variation of, a voltage, current, electromagnetic wave, or electrical pulse that carries information. In certain examples, a signal value may be interpreted by a processor, with the interpreted information to then be translated to a digital format to be passed a data stream or stored in memory, e.g. volatile or nonvolatile semiconductor memory. As used herein, an “eye-mark” refers generally to a geometrical shape, fiducial, or other visual feature that may be placed in the focal plane of a sensor used as a reference point, e.g. for establishing a registration point for alignment of a web. In particular examples, the eye-mark may be a square or other rectangular shape.

Continuing with the example of FIG. 1, system 100 includes a second optical sensor 104 that is positioned adjacent to the web path and downstream of the first optical sensor 102. The second optical sensor is to emit a second sensor beam that is to be at a lateral position relative to the web path that is offset from the lateral position of the first sensor beam. The second optical sensor to produce a second signal value upon its detection of the eye-mark as the web is moved along the web path. In examples, the lateral offset of the second sensor beam from the first sensor beam may be measured from a lateral center line of the first sensor beam to a lateral center line of the second sensor beam. In a particular example, the width of the web is approximately 760 mm, and the offset of the first and second sensor beam is between 100 µm and 600 µm. In other examples, the lateral offset may be greater or lesser depending upon a width of the web. In examples, the amount of the lateral offset will depend on the width of eye-mark and width of the first and second sensor beam widths. For instance, if the web is wide, e.g., 2 m to 10 m, the eye-mark may be, for example 20 mm, and the first and second beam widths may be, for example 5 mm, and the lateral offset may be 5000 µm. Such different web widths and different offset distances are contemplated by this disclosure.

In examples, the offset between the first and second sensor beams is measured from a lateral center line of the first sensor beam to a lateral center line of the second sensor beam. In other examples, the offset between the first and second sensor beams could be measured from an edge of the first sensor beam (e.g., a first sensor beam edge closest to a lateral edge of the web) to a corresponding edge of the second sensor beam (e.g., a second sensor beam edge closest to that lateral edge of the web).

Continuing with the example of FIG. 1, system 100 includes a web misalignment determination engine 106, representing generally a combination of hardware and programming that is to determine lateral misalignment of the web based upon the first signal value, the second signal value, and the lateral offset of the second sensor beam from the first sensor beam

In examples, the WM determination engine 106 is to determine a degree of lateral web misalignment by comparing the first signal value (produced by the first optical sensor 102) and/or the second signal value (produced by the second optical sensor 104) to an expected signal value associated with the web being in correct lateral alignment. In an example, the expected signal value may be a value that is associated with a previous measurement of sensor signal value when another eye-mark was fully overlapped with the first and second optical sensors as another eye-mark moved with the web past the first and second optical sensors. In an example, the expected signal value may be a predetermined value. In an example, the WM determination engine 106 is to compare the first signal value and the second signal value to the expected signal value, and determine a degree of lateral web misalignment that is proportional to a degree to which the first value and/or the second signal value is less than the expected signal value.

Continuing with the example of FIG. 1, In an example the WM determination engine 106 is to, when at least one of the first and second signal values is less than an expected signal value associated with the web being in correct alignment, determine a direction of lateral web misalignment. The direction of lateral web misalignment is determined in consideration of the lateral offset. In examples, the consideration of the lateral offset may be a consideration of the relative lateral positions of the first and second sensor beams as they are directed upon a length of web.

In a particular example, if the first signal value is determined to be less than the second signal value, the WM determination engine 106 is to determine that the direction of lateral web misalignment points towards a lateral edge of the web that is closer to a lateral center line of the second sensor beam than to a lateral center line of the first sensor beam. As used herein, “a direction of lateral web misalignment points towards” refers generally to the web having been misaligned or shifted in that direction. As used herein, “lateral center line” of a sensor beam refers generally to an imaginary line that bisects the width of that sensor beam. Similarly, if the second signal value is determined to be less than the first signal value, the WM determination engine is to determine that the direction of lateral web misalignment points towards a lateral edge of the web that is closer to a lateral center line of the first sensor beam than to a lateral center line of the second sensor beam.

In examples, the first and second optical sensors 102 104 that are included in system 100 are sensors positioned within or adjacent to a printer, and the web is a web that is to be fed through that printer so as to be marked upon. In these examples, the first and/or second optical sensors 102 104 may also be utilized by the printer in other processes, e.g. assessing correct registration of images printed on the web. In examples the first and/or second optical sensors 102 104, in addition to their function in determining lateral web misalignment via system 100, may be also utilized in simplex registration processes where images are printed on a single side of a web media. In other examples, the first and second optical sensors 102 104 may be utilized in duplex registration processes where images are printed on a front and back sides of a web media.

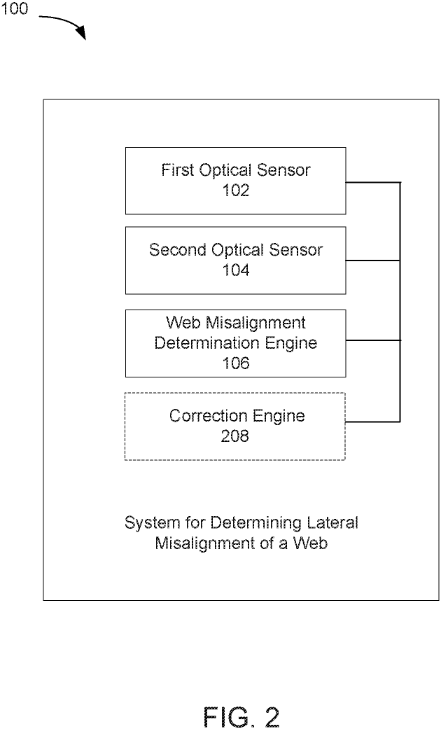

Moving to FIG. 2, in certain examples the system 100 for determining misalignment of a web may include a correction engine 208, representing generally a combination of hardware and programming that is to initiate a corrective measure if the determined lateral web misalignment exceeds a preestablished threshold. In an example, the corrective action may to initiate or cause sending of a user alert of the determined lateral web misalignment. With this information a user, e.g. an operator of a device, e.g., a printer, that includes system 100, can undertake corrective actions to realign the web to a correct alignment. In some examples where the device is a printer, the corrective actions may be taken while printing continues at the printer. In other examples where the device is a printer, the corrective actions may take place as part of a service routine that occurs between print jobs or print frames, or while printing operations are paused. In other examples, the corrective action may be to send data or instructions to another system, e.g. a web alignment system at a printer or other device that includes or acts upon a web, to cause an automatic web realignment to a correct lateral position.

As used herein, “printer”, “press”, “printing apparatus”, and “printing device” are used synonymously and refer generally to any electronic device or group of electronic devices that consume a marking agent to produce a printed print job or form an image upon a media. As used herein, “marking agent” refers generally to any substance that can be applied upon a media by a printer during a printing operation to form an image upon a media, including but not limited to an ink. In examples, a printer may be, but is not limited to, a liquid inkjet printer, liquid ink, a liquid toner-based printer, a LEP printer that utilizes electrostatic printing fluid and a blanket, or a dry toner printer. The term “printer” includes a multifunctional device that performs a function such as scanning and/or copying in addition to printing. As used herein, a “job” and “print job” are used synonymously and refer generally to content, e.g., an image, and/or instructions as to formatting and presentation of the content to be sent to a printer for printing. In examples, a print job may be stored in a programming language and/or a numerical form so that the job can be stored and used in computing devices, servers, printers and other machines capable of performing calculations and manipulating data. As used herein, an “image” refers generally to a rendering of an object, scene, person, or abstraction such text or a geometric shape. As used herein a “printing operation” refers generally to a print job receipt operation, a primer application operation, a marketing agent application operation, a drying operation, an overcoat application, a duplexing operation, a printer calibration operation, or any other process taking place at the printer that is to create, or set up the printer to create, a printed print job on a web media.

In the foregoing discussion of FIGS. 1 and 2, WM determination engine 106 and correction engine 208 were described as combinations of hardware and programming. Engines 106 and 208 may be implemented in a number of fashions. Looking at FIG. 3 the programming may be processor executable instructions stored on a tangible memory resource 330 and the hardware may include a processing resource 340 for executing those instructions. Thus, memory resource 330 can be said to store program instructions that when executed by processing resource 340 implement system 100 of FIGS. 1 and 2.

Memory resource 330 represents generally any number of memory components capable of storing instructions that can be executed by processing resource 340. Memory resource 330 is non-transitory in the sense that it does not encompass a transitory signal but instead is made up of a memory component or memory components to store the instructions. Memory resource 330 may be implemented in a single device or distributed across devices. Likewise, processing resource 340 represents any number of processors capable of executing instructions stored by memory resource 330. Processing resource 340 may be integrated in a single device or distributed across devices. Further, memory resource 330 may be fully or partially integrated in the same device as processing resource 340, or it may be separate but accessible to that device and processing resource 340.

In one example, the program instructions can be part of an installation package that when installed can be executed by processing resource 340 to implement system 100. In this case, memory resource 330 may be a portable medium such as a CD, DVD, or flash drive or a memory maintained by a server from which the installation package can be downloaded and installed. In another example, the program instructions may be part of an application or applications already installed. Here, memory resource 330 can include integrated memory such as a hard drive, solid state drive, or the like.

In FIG. 3, the executable program instructions stored in memory resource 330 are depicted as web misalignment determination module (sometimes referred to herein as “WM determination module”) 306 and correction module 308. WM determination module 306 represents program instructions that when executed by processing resource 340 may perform any of the functionalities described above in relation to WM determination engine 106 of FIG. 1. Correction module 308 represents program instructions that when executed by processing resource 340 may perform any of the functionalities described above in relation to correction engine 208 of FIG. 2.

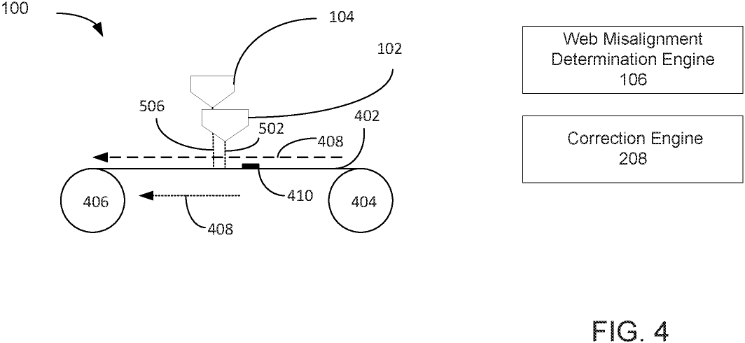

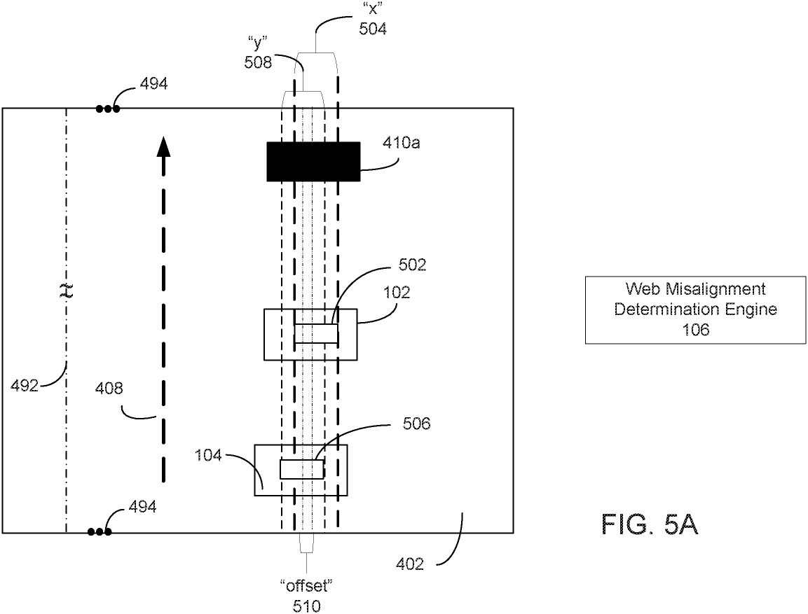

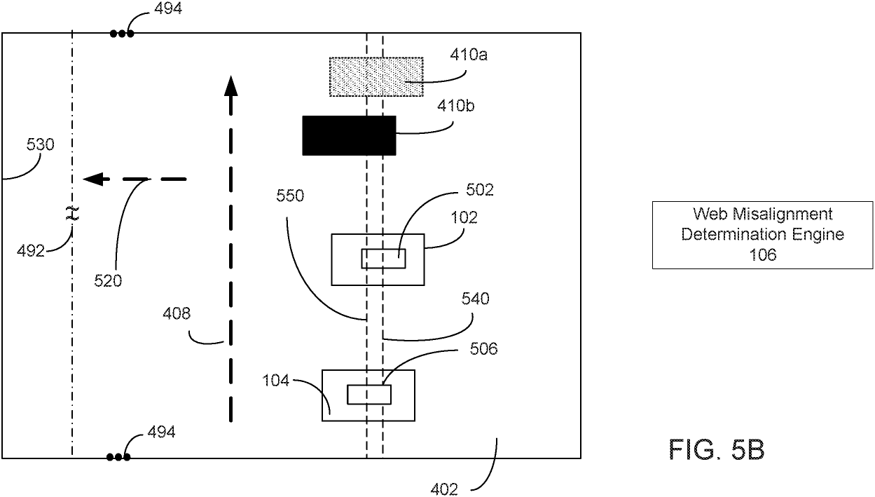

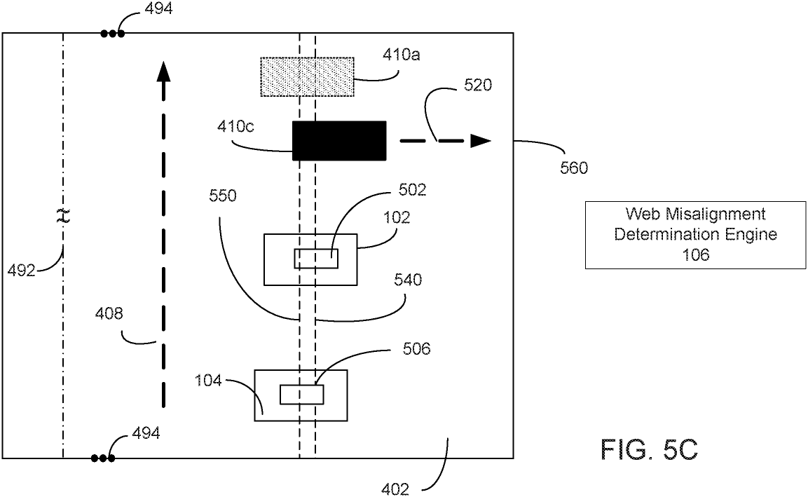

FIGS. 4, 5A, 5B, and 5C are simple schematic diagrams that illustrate an example of a system for determining lateral misalignment of a web. Starting at FIG. 4, in this example system 100 for determining a misalignment of a web 402 includes a first optical sensor 102, a second optical sensor 104, a feeder reel 404, a take-up reel 406, a WM determination engine 106, and a correction engine 208. The feeder reel 404 feeds a web 402 along a web path 408, the web to be collected upon the take-up reel 406. The web 402 includes an eye-mark 410, the eye-mark to be detected by the first and second optical sensors 102 and 104. WM determination engine 106 is to determine lateral misalignment of the web based upon a first signal value produced by the first sensor 102 as the eye-mark 410 is detected, a second signal value produced by the second sensor 104 as the eye-mark 410 is detected, and the existence of a lateral offset between the beams of the first and second sensors 102 104. In examples, correction engine 208 is to initiate a corrective measure if the determined lateral web misalignment exceeds a preestablished threshold.

Moving to FIG. 5A, the first optical sensor 102 is positioned adjacent to a web path 408 and is to have a first sensor beam 502 at a lateral position “x” 504 relative to the web path 408. The second optical sensor 104 is positioned adjacent to the web path 408, downstream of the first optical sensor 104 relative to the web path 408 direction. The second optical sensor 104 emits a second sensor beam 506 at a lateral position “y” 508, relative to the web path 408, that is offset 510 from the lateral position “x” 504.

WM determination engine 106 is to identify a first signal value produced by the first optical sensor 102 as the first optical sensor 102 detects an eye-mark 410a as the web 402 is moved along the web path 408. WM determination engine 106 is to identify a second signal value as the second optical sensor 104 detects the eye-mark 410a.

WM determination engine 106 is to determine a degree and direction of lateral misalignment of the web based upon the identified first signal value, the identified second signal value, and the lateral offset 510 of the first sensor beam 502 from the second sensor beam 506.

Looking at FIG. 5A, in this figure the web 402 is has correct lateral alignment as the eye-mark 410a, as it is moved with the web 402 past the first and second optical sensors 102 104, completely overlaps both the first sensor beam 502 and the second sensor beam 506. Here the WM determination engine 106 is to determine a zero degree of misalignment (no misalignment, e.g. that the web is in correct alignment), as both the first signal value and the second signal value are not less than an expected sensor value.

In examples, the expected sensor signal value is a signal value associated with the eye-mark 410a being in correct alignment so as to completely overlap both the first and second sensor beams 502 506 as the web 402 is advanced along the web path 408. In a particular example, previous to the first and second optical sensors 102 identifying a signal value for a subject eye-mark during a printing operation, the WM determination engine 106 is to determine or identify the expected signal value. In an example, the WM determination engine 106 is to identify as the expected signal value a signal value read by the first optical sensor 102 or the second optical sensor 104 as an eye-mark, separate and distinct from the subject eye-mark, that is printed upon the web is moved past that sensor in a lateral position such that the separate eye-mark was fully overlapped with that sensor. In some examples, the determination or identification of the expected signal value may occur during a non-production printing operation (e.g. a non-printing calibration cycle, or a null cycle). In other examples, the determination or identification of the expected signal value may occur during a production printing operation (e.g., a printing cycle in which marking agent is applied to a media to form an image that is other than an image formed for calibration or servicing purposes) utilizing signal readings taken of a separate eye-mark that is exposed to the first and second optical sensors 102 104 previous to the exposure of the subject eye-mark 410a to the first and second optical sensors 102 104.

Moving to FIG. 5B, in this example, the WM determination engine 106 determines that the web 402 is laterally misaligned as at least one of the first signal value produced by first optical sensor 102 and the second signal value produced by second optical sensor 104 is less than the expected signal value. In the example of FIG. 5B the second signal value produced by second optical sensor 104 is equal to or substantially equal to the expected signal value as when the eye-mark 410b, when moved with the web 402 past the second optical sensor 104, fully overlaps the second sensor beam 506. However, the first signal value produced by first optical sensor 102 is less than the expected signal value as when the eye-mark 410b, when moved with the web 402 past the first sensor 102, does not completely overlap the first sensor beam 502.

In particular examples, the eye-mark 410b may be between 6 mm and 8 mm, and the width of each of the first and second sensor beams may be between 4.0 mm and 4.2 mm. However, other dimensions for the eye-mark and the first and second sensor beams are may be implemented, and are expressly contemplated by this disclosure.

Continuing at FIG. 5B, in examples, WM determination engine 106 is to determine a degree of lateral web misalignment, wherein the degree to which the value of the first optical sensor signal is less than the expected signal value is proportional with the degree of web misalignment.

Continuing at FIG. 5B, in examples, WM determination engine 106 is to determine a direction of web misalignment. Here the WM determination engine 106 determines, based upon identifying that the first signal value (produced by the first optical sensor 102 as the eye-mark 410b passes the first sensor beam 502) is less than the second signal value (produced by the second optical sensor 104 as the eye-mark 410b passes the second sensor beam 506), that the direction 520 of lateral web misalignment points towards a lateral edge 530 of the web 402 that is closer to a lateral center line 550 of the second sensor beam 506 than to a lateral center line 540 of the first sensor beam 502.

Moving to FIG. 5C, in this example, the WM determination engine 106 determines that the web 402 is laterally misaligned as at least one of the first signal value produced by first optical sensor 102 and the second signal value produced by second optical sensor 104 is less than the expected signal value. In the example of FIG. 5C the first signal value produced by first optical sensor 102 is equal to or substantially equal to the expected signal value as when the eye-mark 410c, when moved with the web 402 past the first sensor 102, fully overlaps the first sensor beam 502. However, the second signal value produced by second optical sensor 104 is less than the expected signal value as when the eye-mark 410c, when moved with the web 402 past the second optical sensor 104, does not completely overlap the second sensor beam 506.

Continuing at FIG. 5C, in examples, WM determination engine 106 is to determine a degree of lateral web misalignment, wherein the degree to which the value of the second sensor signal is less than the expected signal value is proportional with the degree of web misalignment.

Continuing at FIG. 5C, in examples, WM determination engine 106 is to determine a direction of web misalignment. Here the WM determination engine 106 determines, based upon identifying that the second signal value (produced by the second optical sensor 104 as the eye-mark 410c passes the second sensor beam 506) is less than the first signal value (produced by the first sensor 102 as the eye-mark 410c passes the first sensor beam 502), that the direction 520 of lateral web misalignment points towards a lateral edge 560 of the web 402 that is closer to a lateral center line 540 of the first sensor beam 506 than to a lateral center line 550 of the second sensor beam 506.

For illustrative purposes, each of FIG. 5B and FIG. 5C includes, shown as an eye-mark 410a with a shadow fill and dotted line edges, a representation of an eye-mark position that would completely overlap both the first sensor beam 502 and the second sensor beam 506, such that the WM determination engine 106 would determine a zero degree of misalignment (no misalignment, e.g. that the web is in correct alignment).

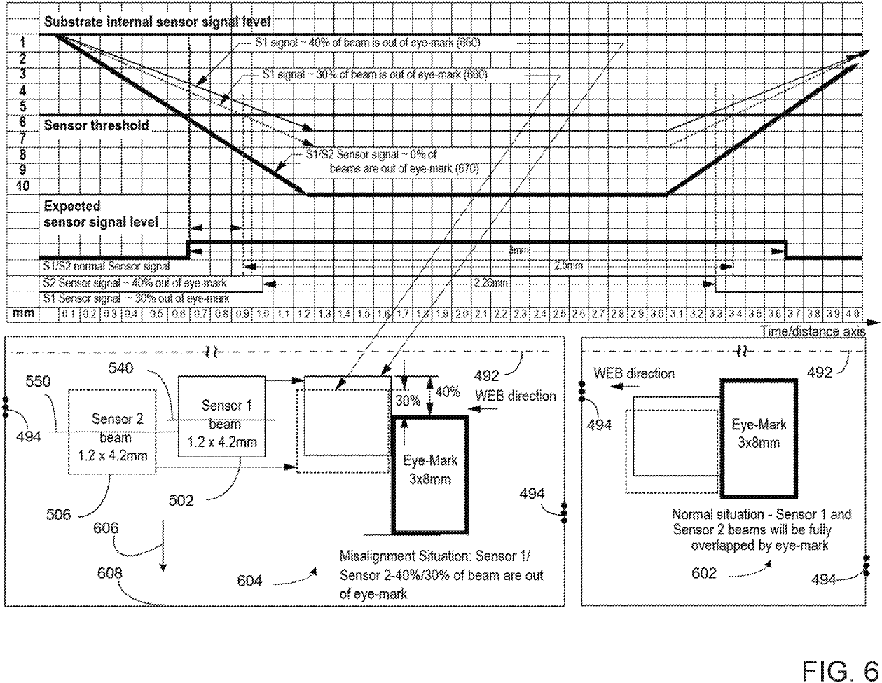

FIG. 6 includes a simple schematic diagram and a corresponding chart that illustrate an example of a system for determining lateral misalignment of a web. In this example, lateral web misalignment determination system 100 is to determine lateral misalignment of the web based upon the signal values of a first sensor (“Sensor 1” or “S1”) and a second sensor (“Sensor 2” or “S2”). In this example, Sensor 1 has a sensor beam 502 (also sometimes referred to in FIG. 6 as a “spot”) of dimensions 1.2 mm × 4 mm. Sensor 2 has a sensor beam 506 of dimensions 1.2 mm x 4 mm. In this example, the eye-mark 410 that is to be detected by Sensor 1 and Sensor 2 has dimensions of 3 mm × 8 mm. In examples, system 100 is to determine a degree of lateral web misalignment by comparing a Sensor 1 signal value 650 and a Sensor 2 signal value 660 to an expected signal value 670 associated with the web being in correct lateral alignment.

In the example of FIG. 6, the expected signal value 670 is associated with the “Normal Situation” 602 at the lower right corner of FIG. 6, illustrating where an eye-mark 410 is fully overlapped with Sensor 1 beam and Sensor 2 beam as the eye-mark 410 is moved with the web past Sensor 1 and Sensor 2.

In an example, system 100 is to compare the Sensor 1 signal value 650 and the Sensor 2 signal value 660 to the expected signal value 670, and determine a degree of lateral web misalignment that is proportional to a degree to which the Sensor 1 signal and/or the Sensor 2 signal value is less than the expected signal value. Looking at the “Misalignment Situation” 604 illustrated at the bottom center of FIG. 6, Sensor 1 and Sensor 2 are offset such that as the eye-mark 410 is moved past Sensor 1 and Sensor 2 along the web path 408, the Sensor 1 sensor beam 502 is 40% out of eye-mark (that is, the eye-mark 410 is only 60% overlapped with Sensor 1), and Sensor 2 sensor beam 506 is 30% out of eye-mark (that is, the eye-mark 410 is only 70% overlapped with Sensor 2). In this situation, when Sensor 1 detects the 3 mm length eye-mark 410, it creates a Sensor 1 sensor signal 650 as if the eye-mark 410 was only 2.26 mm in length 652. In this situation, when Sensor 2 detects the 3 mm length eye-mark 410, it creates a Sensor 2 sensor signal 660 as if the eye-mark 410 was only 2.5 mm in length.

Continuing with the example of FIG. 6, system 100 is to, as at least one of Sensor 1 and Sensor 2 signal values 650 660 is less than the expected signal value 670 associated with the web being in correct alignment, determine that a condition of lateral web misalignment exists. In this particular example, both the Sensor 1 and the Sensor 2 signal values 650 660 are less than the expected signal value 670.

Continuing with the example of FIG. 6, system 100 may determine a direction of lateral web misalignment 606 is consideration of the lateral offset of the Sensor 1 and Sensor 2 sensor beams. In this example, as the Sensor 1 signal value 650 is determined to be less than the Sensor 2 signal value 660, system 100 is to determine that the direction 606 of lateral web misalignment points towards a lateral edge 608 of the web that is closer to a lateral center line 550 of the Sensor 2 sensor beam 506 than to a lateral center line 540 of the Sensor 1 sensor beam 502. Accordingly, in the example depicted in FIG. 6 system 100 determines that the web is misaligned due to a web shift in web shift direction 606.

For sake of clarity a hashed line 492 is illustrated in each of FIGS. 5A-5C and FIG. 6 to denote that the web 402 may be wider than depicted, e.g. wider than is possible to depict at scale with detail in the figures. Also, for sake of clarity in each of FIGS. 5A-5C and FIG. 6 an ellipses 494 is illustrated to denote that a full length of the web may not be depicted in the figures.

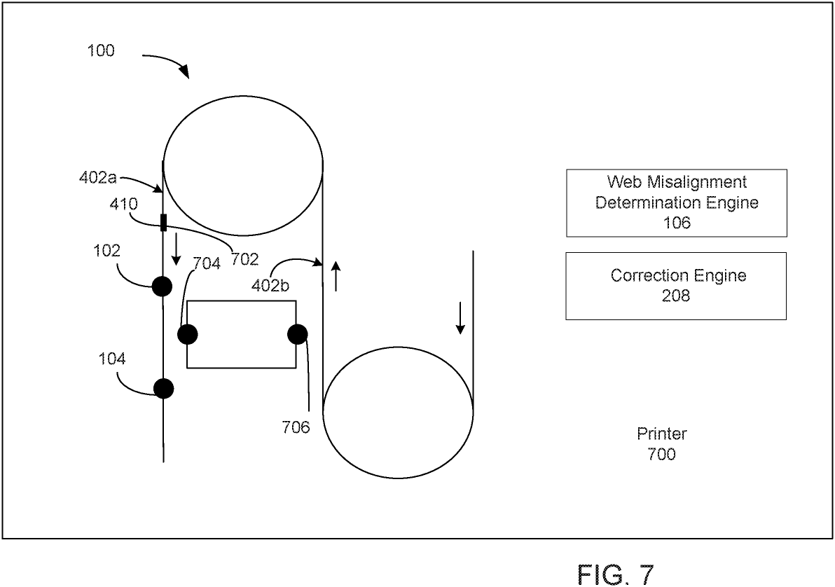

FIG. 7 is a simple schematic diagram that illustrates an example of system 100 for determining lateral misalignment of a web, where the first and second optical sensors 102 and 104 are positioned within a printer 700. In this example, the web is fed through the printer 700. A first eye-mark 410 that is printed on a first side 402a of the web 402 is exposed to sensor beams of the first optical sensor 102 and the second optical sensor 104 for purposes of determining lateral web misalignment as described with respect to FIGS. 5A-5C. In this example, the first and second optical sensors 102 104 may also be utilized by the printer 700 in assessing front to back registration of the first eye-mark 410 compared to another eye-mark 702 printed on a second side 402b of the web. In this example, the printer 700 also includes a third optical sensor 704 and a fourth optical sensor 706 to be utilized in making assessments of or determining front to back web registration.

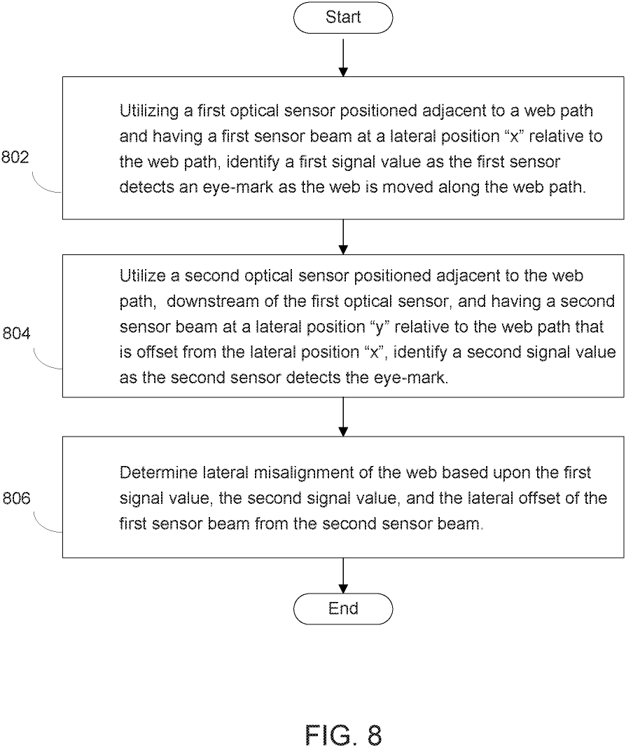

FIG. 8 is a flow diagram of implementation of a method for determining lateral web misalignment. A first optical sensor positioned adjacent to a web path and having a first sensor beam at a lateral position “x” relative to the web path is utilized to identify a first signal value. The first signal value is identified as the first optical sensor detects an eye-mark as the web is moved along the web path (block 802). Referring back to FIGS. 1-3, WM determination engine 106 (FIGS. 1 and 2) or WM determination module 306 (FIG. 3), when executed by processing resource 340, may be responsible for implementing block 802.

A second optical sensor positioned adjacent to the web path, downstream of the first optical sensor, and having a second sensor beam at a lateral position “y” relative to the web path that is offset from the lateral position “x”, is utilized to identify a second signal value. The second signal value is identified as the second sensor detects the eye-mark (block 804). Referring back to FIGS. 1-3, WM determination engine 106 (FIGS. 1 and 2) or WM determination module 306 (FIG. 3), when executed by processing resource 340, may be responsible for implementing block 804.

Lateral misalignment of the web is determined based upon the first signal value, the second signal value, and the lateral offset of the first sensor beam from the second sensor beam (block 806). Referring back to FIGS. 1-3, WM determination engine 106 (FIGS. 1 and 2) or WM determination module 306 (FIG. 3), when executed by processing resource 340, may be responsible for implementing block 806.

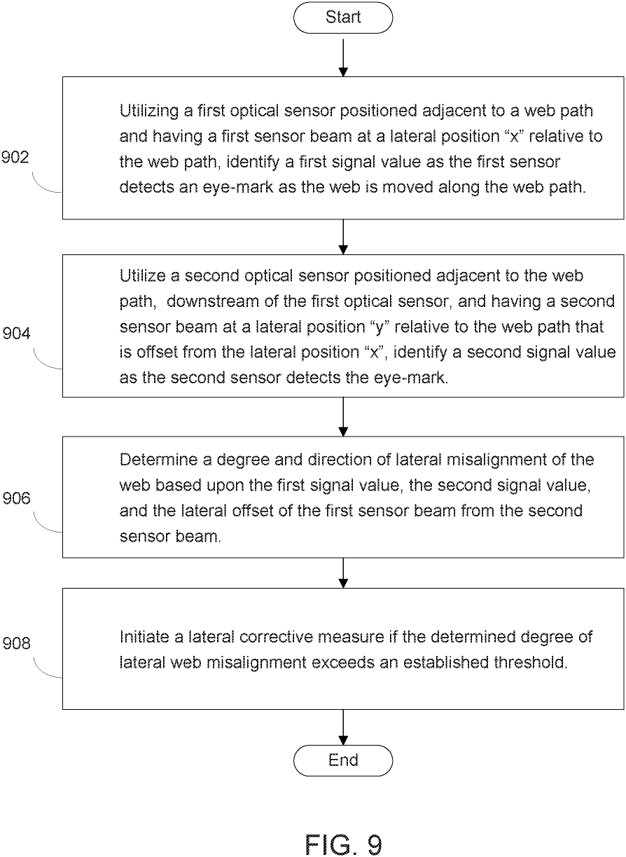

FIG. 9 is a flow diagram of implementation of a method for determining lateral web misalignment. A first optical sensor positioned adjacent to a web path and having a first sensor beam at a lateral position “x” relative to the web path is utilized to identify a first signal value. The first signal value is identified as the first optical sensor detects an eye-mark as the web is moved along the web path (block 902). Referring back to FIGS. 1-3, WM determination engine 106 (FIGS. 1 and 2) or WM determination module 306 (FIG. 3), when executed by processing resource 340, may be responsible for implementing block 902.

A second optical sensor positioned adjacent to the web path, downstream of the first optical sensor, and having a second sensor beam at a lateral position “y” relative to the web path that is offset from the lateral position “x”, is utilized to identify a second signal value. The second signal value is identified as the second sensor detects the eye-mark (block 904). Referring back to FIGS. 1-3, WM determination engine 106 (FIGS. 1 and 2) or WM determination module 306 (FIG. 3), when executed by processing resource 340, may be responsible for implementing block 904.

A degree and direction of lateral misalignment of the web is determined based upon the first signal value, the second signal value, and the lateral offset of the first sensor beam from the second sensor beam (block 906). Referring back to FIGS. 1-3, WM determination engine 106 (FIGS. 1 and 2) or WM determination module 306 (FIG. 3), when executed by processing resource 340, may be responsible for implementing block 906.

A corrective measure is initiated if the determined degree of lateral web misalignment exceeds an established threshold (block 908). Referring back to FIGS. 1-3, correction engine 208 (FIG. 2) or correction module 308 (FIG. 3), when executed by processing resource 340, may be responsible for implementing block 908.

FIGS. 1-9 aid in depicting the architecture, functionality, and operation of various examples. In particular, FIGS. 1-7 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in a memory resource for use by or in connection with a processing resource. A “processing resource” is an instruction execution system such as a computer/processor-based system or an ASIC (Application Specific Integrated Circuit) or other system that can fetch or obtain instructions and data from computer-readable media and execute the instructions contained therein. A “memory resource” is a non-transitory storage media that can contain, store, or maintain programs and data for use by or in connection with the instruction execution system. The term “non-transitory” is used only to clarify that the term media, as used herein, does not encompass a signal. Thus, the memory resource can comprise a physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory (EPROM), flash drives, and portable compact discs.

Although the flow diagrams of FIGS. 8 and 9 show specific orders of execution, the order of execution may differ from that which is depicted. For example, the order of execution of two or more blocks or arrows may be scrambled relative to the order shown. Also, two or more blocks shown in succession may be executed concurrently or with partial concurrence. Such variations are within the scope of the present disclosure.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive. The terms “first”, “second”, “third” and so on in the claims merely distinguish different elements and, unless otherwise stated, are not to be specifically associated with a particular order or particular numbering of elements in the disclosure.

What is claimed is:

1. A system for determining lateral misalignment of a web, comprising:
a first optical sensor positioned adjacent to a web path, wherein the first optical sensor is to emit a first sensor beam and produce a first signal value upon its detection of an eye-mark as the web is moved along the web path;
a second optical sensor positioned adjacent to the web path and downstream of the first optical sensor, the second optical sensor to emit a second sensor beam that is to be at a lateral position relative to the web path that is offset from the lateral position of the first sensor beam, and the second optical sensor to produce a second signal value upon its detection of the eye-mark as the web is moved along the web path; and
a web misalignment determination engine (“WM determination engine”) that is to determine lateral misalignment of the web based upon the first signal value, the second signal value, and the lateral offset of the second sensor beam from the first sensor beam.

2. The system of claim 1, wherein the WM determination engine is to determine a degree of web misalignment by comparing the first signal value and/or the second signal value to an expected signal value associated with the web being in correct alignment.

3. The system of claim 2, wherein the eye-mark is a first eye-mark, and wherein the expected signal value is a value associated with a second eye-mark that was fully overlapped with the first and second sensor beams as the second eye-mark moved with the web past the first and second sensor beams.

4. The system of claim 2,
wherein the WM determination engine is to compare the first signal value and the second signal value to the expected signal value; and
wherein the degree to which the first value or the second signal values is less than the expected signal value is proportional with the degree of web misalignment.

5. The system of claim 1,
the WM determination engine is to determine, when at least one of the first and second signal values is less than an expected signal value associated with the web being in correct alignment, a direction of lateral web misalignment in consideration of the lateral offset and the relative positions of the first and second sensor beams.

6. The system of claim 5, wherein
if the first signal value is less than the second signal value, the WM determination engine is to determine that the direction of lateral web misalignment points towards a lateral edge of the web that is closer to a lateral center line of the second sensor beam than to a lateral center line of the first sensor beam; and
if the second signal value is less than the first signal value, the WM determination engine is to determine that the direction of lateral web misalignment points towards a lateral edge of the web that is closer to a lateral center line of the first sensor beam than to a lateral center line of the second sensor beam.

7. The system of claim 1, further comprising a correction engine to initiate an alert of lateral web misalignment or other corrective measure if the determined lateral web misalignment exceeds a preestablished threshold.

8. The system of claim 1,
wherein the first and second optical sensors are positioned within or adjacent to a printer;
wherein the web is a web fed through the printer;
wherein the eye-mark is a first eye-mark and is printed on a first side of the web; and
wherein the first and second optical sensors are sensors also utilized by the printer in assessing front to back registration of the first eye-mark compared to a second eye-mark printed on a second side of the web.

9. A method for determining lateral misalignment of a web, comprising:
utilizing a first optical sensor positioned adjacent to a web path and having a first sensor beam at a lateral position “x” relative to the web path, identify a first signal value as the first optical sensor detects an eye-mark as the web is moved along the web path;
utilizing a second optical sensor positioned adjacent to the web path, downstream of the first optical sensor, and having a second sensor beam at a lateral position “y” relative to the web path that is offset from the lateral position “x”, identify a second signal value as the second optical sensor detects the eye-mark; and
determining a degree and direction of lateral misalignment of the web based upon the first signal value, the second signal value, and the lateral offset of the first sensor beam from the second sensor beam.

10. The method of claim 9, wherein determining the degree of web lateral misalignment includes comparing the first signal value and/or the second signal value to an expected signal value associated with the web being in correct alignment.

11. The method of claim 9, when at least one of the first and second signal values is less than an expected signal value associated with the web being in correct alignment, further comprising determining the direction of web lateral misalignment by if the first signal value is less than the second signal value, determining that the direction of lateral web misalignment points towards a lateral edge of the web that is closer to a lateral center line of the second sensor beam than to a lateral center line of the first sensor beam; and
if the second signal value is less than the first signal value, determining that the direction of lateral web misalignment points towards a lateral edge of the web that is closer to a lateral center line of the first sensor beam than to a lateral center line of the second sensor beam.

12. The method of claim 11,
wherein the eye-mark is a first eye-mark; and
further comprising, while moving a second eye-mark printed upon the web past the first or the second sensor beam such that the second eye-mark is fully overlapped with that sensor beam, identifying a signal value of that sensor as the expected signal value.

13. The method of claim 12, wherein , the second eye-mark is moved past the first and the second sensor beams as part of a production printing operation.

14. The method of claim 12, wherein , the second eye-mark is moved past the first and the second sensor beams as part of a non-production printing operation.

15. A memory resource storing instructions that when executed are to cause a processing resource to determine lateral misalignment of a web, comprising:
a lateral web misalignment module, to
cause the processing resource to receive data indicative of a first signal value that was produced as a first optical sensor emits a first sensor beam and detects an eye-mark as a web is moved along the web path, wherein the first optical sensor is positioned adjacent to a web path and the first optical sensor beam has a lateral position “x” relative to the web path; and
cause the processing resource to receive data indicative of a second signal value that was produced as a second optical sensor emits a second sensor beam and detects the eye-mark as the web is moved along the web path, wherein the second optical sensor is positioned adjacent to the web path and the second sensor beam has a lateral position “y” relative to the web path that is offset from the lateral position “x”;
a web misalignment determination module, to cause the processing resource to, when at least one of the first and second signal values is less than an expected signal value associated with the web being in correct alignment,
determine a degree of web lateral misalignment by comparing the first signal value and/or the second signal value to the expected signal value; and
determine the direction of lateral web misalignment in consideration of the first and second signal values and a direction of lateral offset of the first sensor beam from the second sensor beam; and
a correction module, to cause the processing resource to initiate a corrective measure if the determined degree of lateral web misalignment exceeds a preestablished threshold.
